(19) United States
(12) Patent Application Publication
(10) Pub. No.: US 2004/0198411 A1
(43) Pub. Date: Oct. 7, 2004

(54) ANTENNA EXTENSION CONTROL FOR A MOBILE COMMUNICATIONS DEVICE

(76) Inventors: Steven D. Cheng, San Diego, CA (US); Kamran Ramezan, San Diego, CA (US)

Correspondence Address: NAIPO (NORTH AMERICA INTERNATIONAL PATENT OFFICE), P.O. BOX 506, MERRIFIELD, VA, 22116, US

(21) Appl. No.: 10/248,993

(22) Filed: Mar. 7, 2003

(51) Int. Cl. H04Q 7/32

(52) U.S. Cl. 455/550.1; 455/575.1; 455/90.1

(57) ABSTRACT

A method for controlling extension of an antenna in a communications device. The communications device contains an antenna capable of being extended. The method includes detecting occurrence of an event selected from a group consisting of: starting a radio frequency (RF) spectrum scan, starting a data packet transfer, entering a discontinuous reception (DRX) wake up mode, starting a phone call, and starting an emergency phone call. In response to the detection of the event, the method also includes causing the antenna to be extended. The antenna can be extended manually or extended automatically with a motor.

### BACKGROUND OF INVENTION

1. Field of the Invention

The present invention relates to a mobile communications device with an extendable antenna, and more specifically, to a method for extending and retracting the extendable antenna in response to an event.

2. Description of the Prior Art

Mobile stations such as cellular phones commonly use an extendable antenna to improve reception and transmission of signals. Please refer to FIG. 1A and FIG. 1B. FIG. 1A is a diagram of a prior art mobile station 10 with an antenna 12 in a retracted state. FIG. 1B is a diagram of the mobile station 10 with the antenna 12 in an extended state. To go from the retracted state to the extended state, the antenna 12 can be pulled in direction 16. On the other hand, to go from the extended state to the retracted state, the antenna 12 can be pushed in direction 14. Extending and retracting the antenna 12 affects a Received Signal Strength Indicator (RSSI) level of signals received by the mobile station 10.

The mobile station 10 uses the antenna 12 to transmit signals to and receive signals from base stations. In order to reduce interference effects between received signals and transmitted signals, the transmitted signals are designed to be much stronger than the received signals. The range of the RSSI for received signals varies from −70 dBm to −104 dBm in CDMA. When the RSSI level is close to −104 dBm, the chance of call drop increases. Therefore, by increasing the RSSI level, the call drop problem can be improved. One possibility of increasing the RSSI level is to extend the antenna 12 of the mobile station 10. However, this is only a solution for mobile stations that have an extendable antenna.

Please refer to FIG. 2. FIG. 2 is a chart comparing RSSI signals when the antenna 12 is retracted and extended. Signal 20 shows the RSSI level when the antenna 12 is retracted, and signal 22 shows the RSSI level when the antenna 12 is extended. Each of these signals 20, 22 was recorded in a laboratory, and compares the RSSI levels (measured in dBm) over time (measured in seconds). Based on the laboratory test results, extending the antenna 12 can increase the RSSI level from several dBm to over 10 dBm. This improvement can help to reduce the call drop rate. In addition, the improvement in RSSI level also allows the mobile station 10 to increase a base station paging rate, in which the mobile station 10 pages different channel frequencies to see if a channel with better reception is available.

With modern mobile stations, size of the mobile station 10 is a common concern. Therefore, the manufacturer of the mobile station 10 will often hide the antenna 12 when it is not needed. For this kind of design, it is assumed that users of the mobile station 10 will extend the antenna 12 when they need the antenna 12 and retract it when it is not needed. However, users of the mobile station 10 often forget to extend the antenna 12, and transmission quality will be affected accordingly.

In order to solve this problem, many proposals have been introduced. In U.S. Pat. No. 6,301,469 B1, Kim teaches a “Method for automatically switching antenna mode in portable telephone”, which is herein incorporated by reference. Please refer to FIG. 3A and FIG. 3B. FIG. 3A and FIG. 3B are diagrams of a prior art mobile station 30 having a motor 34 for controlling extension and retraction of an antenna 32. FIG. 3A is a diagram of the mobile station 30 with the antenna 32 in a retracted state. FIG. 3B is a diagram of the mobile station 30 with the antenna 32 in an extended state. The mobile station 30 also contains a display 36, such as an LCD, and a speaker 38. To go from the retracted state to the extended state, the motor 34 extends the antenna 32 in direction 16. On the other hand, to go from the extended state to the retracted state, the motor 34 retracts the antenna 32 in direction 14. The mobile station 30 is capable of automatically extending or retracting the antenna 32 with the aid of the motor 34. Therefore, the user of the mobile station 30 does not need to manually extend or retract the antenna 32, eliminating the potential for the user to forget to extend the antenna 32 and to experience call drop.

Please refer to FIG. 4. FIG. 4 is a flowchart of a prior art method for extending and retracting the antenna 32 of the mobile station 30. Steps contained in the flowchart will be explained below.

Step 50: Start a phone call;

Step 52: Determine if the antenna 32 is retracted; if so, go to step 54; if not, go to step 66;

Step 54: Determine if an antenna switching control function has been set. A user can set this control function to enable the automatic extension of the antenna 32; if so, go to step 54; if not, go to step 66;

Step 56: Measure the RSSI level of the mobile station 30;

Step 58: Determine if the RSSI level is less than a threshold value; if so, go to step 60; if not, go to step 56;

Step 60: Since the RSSI level was below the threshold value, the motor 34 extends the antenna 32;

Step 62: Determine if the call has been terminated; if so, go to step 64; if not, go back to step 56;

Step 64: Since the call has been terminated, the motor 34 retracts the antenna 32;

Step 66: End.

The prior art method shown in FIG. 4 is used for automatically extending and retracting the antenna 32 with the motor 34. Unfortunately, prior art method requires the mobile station 30 to have the motor 34 installed, adding to the size of the mobile station 30. In addition, the antenna 32 is only extended during a phone call, and not when other events that may also benefit from a higher RSSI level are performed.

### SUMMARY OF INVENTION

It is therefore a primary objective of the claimed invention to provide a method for extending and retracting an extendable antenna of a communications device in response to an event in order to solve the above-mentioned problems.

According to the claimed invention, a method for controlling extension of an antenna in a communications device is provided. The communications device contains an antenna capable of being extended. The method includes detecting occurrence of an event selected from a group consisting of: starting a radio frequency (RF) spectrum scan, starting a data packet transfer, entering a discontinuous reception (DRX) wake up mode, starting a phone call, and starting an emergency phone call. In response to the detection of the event, the method also includes causing the antenna to be extended.

It is an advantage of the claimed invention that the communications device does not require a motor to be installed for extending and retracting an antenna of the communications device. In addition, the claimed invention method extends the antenna for a number of events, and it not limited to extending the antenna only at the start of phone calls.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1A is a diagram of a prior art mobile station with an antenna in a retracted state.

FIG. 1B is a diagram of the mobile station with the antenna in an extended state.

FIG. 2 is a chart comparing RSSI signals when the antenna is retracted and extended.

FIG. 3A and FIG. 3B are diagrams of a prior art mobile station having a motor for controlling extension and retraction of an antenna.

FIG. 4 is a flowchart of a prior art method for extending and retracting the antenna of the mobile station.

FIG. 5 is a functional block diagram of a mobile station according to the present invention.

FIG. 6 is a block diagram of software used to control the mobile station.

FIG. 7 is a flowchart of a present invention method for extending and retracting the antenna of the mobile station.

FIG. 8 is a chart comparing RSSI signals when the mobile station is held in left or right hands.

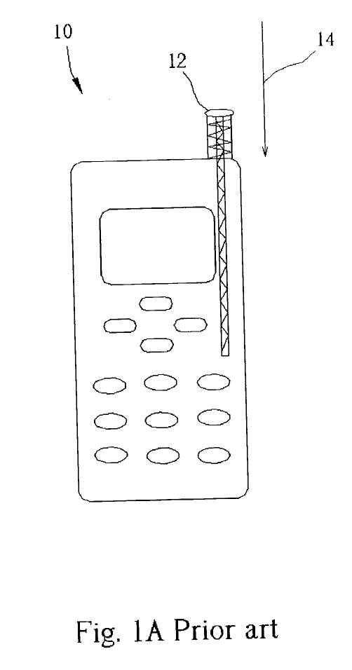

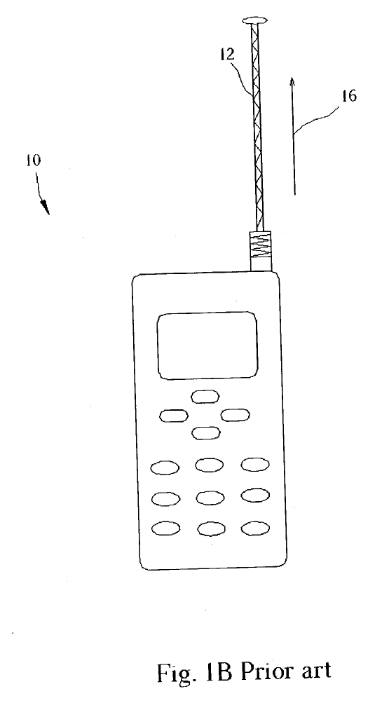

### DETAILED DESCRIPTION

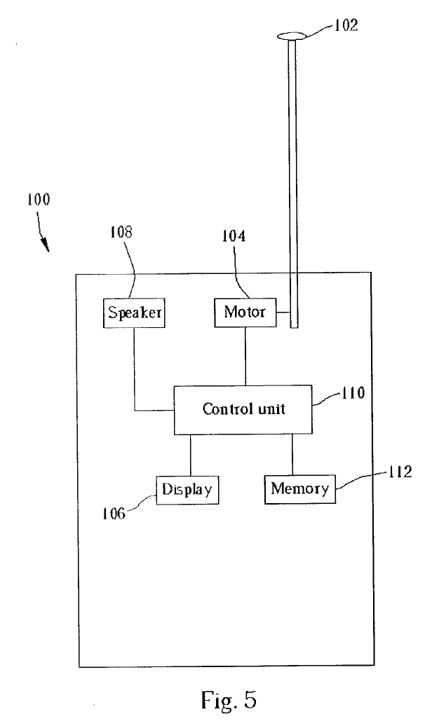

Please refer to FIG. 5. FIG. 5 is a functional block diagram of a mobile station 100 according to the present invention. The mobile station 100 comprises a motor 104 for extending and retracting an antenna 102, a speaker 108 for producing audible tones, and a display 106 such as an LCD for displaying messages. A control unit 110 is used for controlling operation of the speaker 108, motor 104, and display 106. The mobile station 100 also contains a memory 112 for storing programs and data used by the mobile station 100.

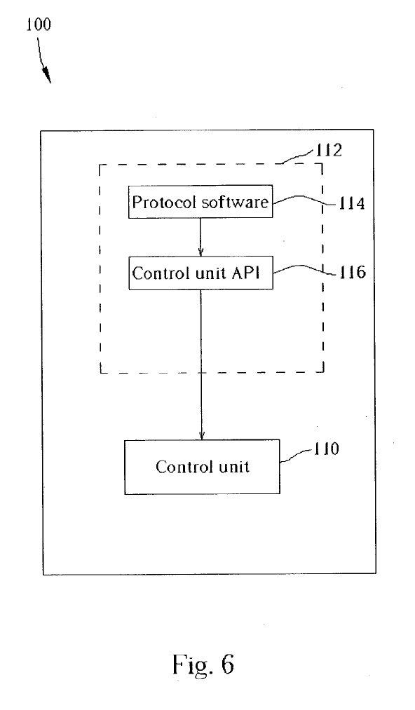

Please refer to FIG. 6. FIG. 6 is a block diagram of software used to control the mobile station 100. Installed in the memory 112 is a control unit application program interface (API) 116 used for allowing software to communicate with the control unit 110. In addition, the memory 112 also contains protocol software 114, which controls the control unit 110 through the control unit API 116. As will be explained below, when the protocol software 114 detects a certain group of events and conditions, the protocol software 114 sends an extend or retract signal to the control unit API 116, which in turn sends the signal to the control unit 110.

The present invention method is capable of being used in mobile stations with or without motors. The mobile station 100 shown in FIG. 5 illustrates all features of the present invention, and will be used in the description below. To fully appreciate the advantages of the present invention, it is necessary to first look at situations in which it is desired to extend and retract the antenna 102.

During a scan of the entire radio frequency (RF) spectrum, the mobile station 100 is interested in measuring RSSI signals from a potential base station and collecting system information from chosen broadcast channels. Thus, during this time, the mobile station 100 will not launch any paging receiving action. The mobile station 100 will start to receive paging messages from the network if it has successfully registered into a suitable cell. When there are some up link and/or down link activities between the mobile station 100 and the network, the mobile station 100 is in the packet transfer mode.

It is desirable to extend the antenna 102 in both the entire RF scan state and the packet transfer state. It should be noted that extending the antenna 102 at the beginning of the RF scan is most useful for mobile stations using the Global System for Mobile Communications (GSM) standard, but can also be used mobile stations that use other communication standards. During the entire RF scan state, the mobile station 100 needs to measure all the frequencies in every band of the RF spectrum in a very short period of time. Then, the mobile station 100 needs to identify broadcasting channels among these strongest frequencies and decode the corresponding system information in a given period. In order to calculate a better measurement result and find more available base stations, extending the antenna 102 will be very beneficial. During the packet transfer state, it is crucial to receive correct data. Thus, having the antenna 102 extended will help to eliminate unnecessary noise. The extended antenna 102 will also make layer 1 scheduling work better in the packet transfer state, because there are other neighbor cell measuring activities that need to be performed during the packet transfer state. Furthermore, the increased dBm gained by using the extended antenna 102 will help the cell change to be done in a graceful way in the packet transfer state. Likewise, during a discontinuous reception (DRX) wake up mode, the mobile station 100 performs a cell reselection function. As a result, it is recommended to extend the extra antenna 102 at the beginning of an RF Scan, when starting a packet transfer, and when entering a DRX wake up mode. It is also recommended to retract the antenna 102 at the end of each of these three events.

The antenna 102 can retract and extend during voice transmissions as well as the other aforementioned mandatory cases. The extended antenna 102 during this scenario will reduce the call drop rate. The antenna 102 can be fully extended in areas where the signal strength is too low and retract when it is not needed. The scenarios related to the signal strength being too low can further be divided into the signal strength of the serving cell being too low or the signal strength of at least one of the six strongest neighbor cells being too low. The former scenario requires that the antenna 102 is extended during the voice or data transaction between the mobile station 100 and the serving cell. The latter scenario requires that the antenna 102 is extended during the cell selection and reselection process proceeded in the DRX wake up mode, where the extended antenna 102 may help to collect a better measurement result from the neighbor cells during a measurement process.

As discussed above, the protocol software 114 can be used to decide whether the antenna 102 should be extended or retracted. When this scheme is applied to work with the motor 104 to make the antenna 102 to be extended and retracted in an automatic way, the user of the mobile station 100 is given the option to disable the automatic antenna 102 temporarily if needed. For example, if the mobile station 100 is used with a hands-free device or secured via a belt clip, it might be desirable to disable the antenna 102 from being extended and retracted with the motor 104. In addition to simply enabling or disabling the automatic antenna 102, the user could also choose to disable extension and retraction of the antenna 102 during voice calls, packet transfers, RF scans, or during any other events.

During DRX mode, the RSSI level is continuously monitored in the cell reselection process. If the RSSI level falls below a certain value and becomes too low, the protocol software 114 sends an “extend” command to the control unit 110 for extending the antenna 102 to achieve a higher RSSI level, and the protocol software 114 will send the “retract” command to the control unit 110 when the routine measurement process is finished.

When the user of the mobile station 100 has made an emergency call, such as calling “911”, it is recommended to keep the antenna 102 in the extended position for a certain period of time after the call has been terminated. This is done to allow easier tracking of the mobile station 100 user by law enforcement authorities.

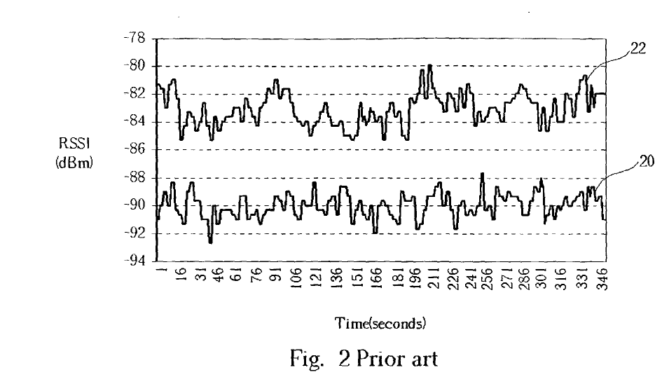

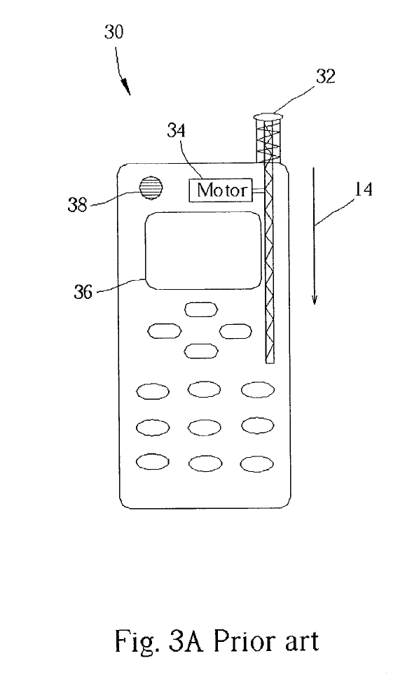

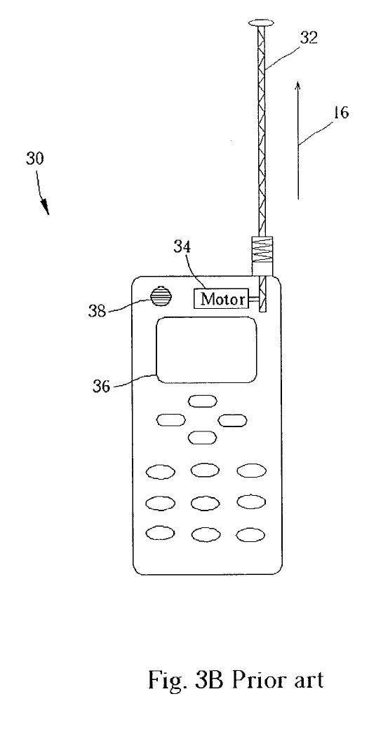

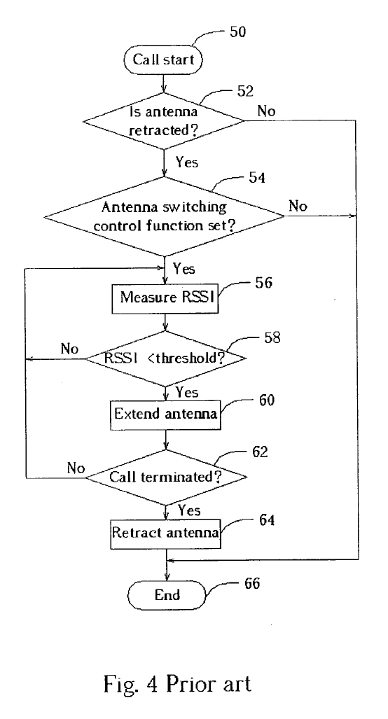

When a mobile station 100 is using a suitable cell, the cell reselection algorithm will be executed routinely. The cell reselection algorithm will measure both the RSSI level of the serving cell and neighbor cells to see whether the serving cell encounters a path loss problem or whether there is a better neighbor cell with a stronger signal than the serving cell. When either case occurs, the serving cell may be changed. As seen in FIG. 2, even when the mobile station 100 is stationary, the RSSI levels vary from time to time. When the mobile station 100 is in a moving state and its value is lower than a given value specified by communications protocols such as GSM, the serving cell will be changed. If a neighbor cell is not changed in time, the service will be terminated. In order to make a graceful transition between the old serving cell and the new serving cell, a proposed scheme considers a running average value of the RSSI. Let the running average value be defined as RVA. If the current RVA value is less than a path loss value C1 plus a threshold value Td value given by the manufacturer, the protocol software 114 will send a signal to indicate that the antenna 102 should be extended.

The present invention method can be used to extend or retract the antennas of mobile stations regardless of whether they contain a motor. For instance, assume that the mobile station 100 contains the motor 104. The control unit 110 is electrically connected to the motor 104, as shown in FIG. 5. When an “extend” command arrives at the control unit 110, the antenna 102 will be extended automatically with the assistance of the motor 104. When a “retract” command arrives at the control unit 110, the extended antenna 102 will be retracted automatically with the assistance of the motor 104. As mentioned before, the mobile station 100 users can override or disable the motor 104 functionality temporarily if they have special purposes of doing so. Also, should the antenna 102 be obstructed by any type of force during extension or retraction, the control unit 110 stops sending signals to the motor momentarily. The control unit 110 then notifies the user with a sound of an alarm through the speaker 108 and/or a message on the display 106 that the antenna 102 could not function properly or could not be extended. The control unit 110 then repeats the extension or retraction process after a predetermined time period.

Even if the mobile station 100 does not contain the motor 104, the present invention method could still be used to notify users that the antenna 102 should be extended or retracted. For example, when the control unit 110 receives an “extend” message from the protocol software 114, the control unit 110 can show a corresponding message on the display 106 to remind the users that they should extend the antenna 102. In addition to or instead of showing a message on the display 106, the control unit 110 can also produce an alarm tone through the speaker 108 to attract the user″s attention. Similarly, the display 106 and/or the speaker 108 can also be used to notify the user that the antenna 102 should be retracted.

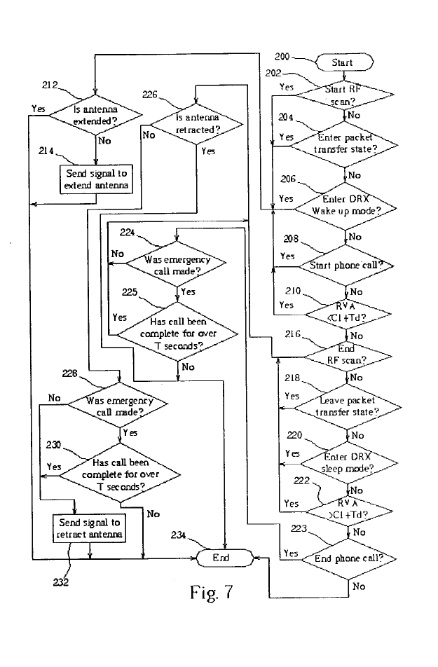

Please refer to FIG. 7. FIG. 7 is a flowchart of a present invention method for extending and retracting the antenna 102 of the mobile station 100. The mobile station 100 will extend or retract the antenna 102 in response to a number of events. Steps contained in the flowchart will be explained below.

Step 200: Start;

Step 202: Determine if an RF scan process has started; if so, go to step 212; if not, go to step 204;

Step 204: Determine if the mobile station 100 has entered a packet transfer state; if so, go to step 212; if not, go to step 206;

Step 206: Determine if the mobile station 100 has entered a DRX wake up mode; if so, go to step 212; if not, go to step 208;

Step 208: Determine if a phone call has started; if so, go to step 212; if not, go to step 210;

Step 210: Determine if a running average value RVA of the RSSI has been less than a path loss value C1 plus a threshold value Td for a predetermined period of time, such as 5 seconds; if so, go to step 212; if not, go to step 216;

Step 212: Determine if the antenna 102 is already extended; if so, go to step 234; if not, go to step 214;

Step 214: The protocol software 114 sends an “extend” signal to the control unit 110. The control unit 110 can automatically extend the antenna 102 with the motor 104, show a message on the display 106, or produce an audible tone with the speaker 108 to notify the user to extend the antenna 102; go to step 234;

Step 216: Determine if an RF scan process has ended; if so, go to step 226; if not, go to step 218;

Step 218: Determine if the mobile station 100 has left a packet transfer state; if so, go to step 226; if not, go to step 220;

Step 220: Determine if the mobile station 100 has entered a DRX sleep mode; if so, go to step 226; if not, go to step 222;

Step 222: Determine if the running average value RVA of the RSSI has been greater than the path loss value C1 plus the threshold value Td for the predetermined period of time, such as 5 seconds; if so, go to step 226; if not, go to step 223;

Step 223: Determine if a phone call has ended; if so, go to step 224; if not, go to step 234;

Step 224: Determine if an emergency call was made, such as dialing “911”; if so, go to step 225; if not, go to step 226;

Step 225: Determine if the emergency call been complete for longer than a predetermined period of time T; if so, go to step 226; if not, the antenna should continue to be extended, go to step 234;

Step 226: Determine if the antenna 102 is already retracted; if so, go to step 234; if not, go to step 228;

Step 228: Determine if an emergency call was made, such as dialing “911”; if so, go to step 230; if not, go to step 232;

Step 230: Determine if the emergency call been complete for longer than a predetermined period of time T; if so, the antenna should be retracted, go to step 232; if not, the antenna should continue to be extended, go to step 234;

Step 232: The protocol software 114 sends a “retract” signal to the control unit 110. The control unit 110 can automatically retract the antenna 102 with the motor 104, show a message on the display 106, or produce an audible tone with the speaker 108 to notify the user to retract the antenna 102; go to step 234;

Step 234: End.

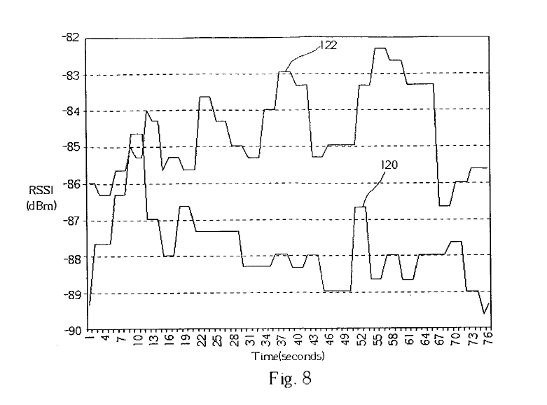

When the mobile station 100 users are in a conversation with another party through the mobile station 100, sometimes they may perceive that the quality of received signals varies according to which hand they use to hold the mobile station 100. Please refer to FIG. 8. FIG. 8 is a chart comparing RSSI signals when the mobile station is held in left or right hands. Signal 120 shows the RSSI level when the mobile station 100 is held in the right hand, and signal 122 shows the RSSI level when the mobile station 100 is held in the left hand.

FIG. 8 contains data from a test result taken in a laboratory, and indicates that the difference in the received RSSI from using the right hand or the left hand for holding the same mobile station 100 can vary up to 8 dBm. This is mainly because part of the signals transmitted from the camped base station is blocked by the mobile station 100 user″s body. In order to alleviate this kind of problem, the present invention method proposes a solution.

Assume that right after the antenna 102 is extended, the RSSI level is still considered too low and the mobile station 100 cannot find a better cell to replace the current serving cell. The mobile station 100 can show a message “Please change the mobile station receiving location to improve the receiving signal quality” on the display 106 of the mobile station 100 with optional audio effects played through the speaker 108 so as to attract the mobile station 100 user″s attention. When the mobile station 100 users receive this message, they can either switch the hand used to hold the mobile station 100, or move to a more open space area to improve the RSSI level. This feature is helpful in reducing the call drop rate, and is especially important when calling an emergency number when the mobile station 100 is in an area with poor signal reception. Since this feature relies on the display 106 and the speaker 108 for alerting the user, this feature can be used on mobile stations with or without an antenna.

Compared to the prior art method of automatically extending and retracting the antenna with the motor, the present invention method is much more versatile. The prior art method requires a motor to be installed in the mobile station, adding to the size of the mobile station. In addition, the prior art method only extends the antenna when the RSSI level is too low during a phone call. On the other hand, the present invention method does not require the mobile station to contain a motor, and instead can notify users that the antenna should be extended or retracted through a display and a speaker. Furthermore, the present invention method extends and retracts the antenna in response to a variety of different events that require higher RSSI levels, giving mobile stations using the present invention method better performance.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for controlling extension of an antenna in a communications device, the communications device comprising an antenna capable of being extended, the method comprising:
detecting occurrence of an event selected from a group consisting of: starting a radio frequency (RF) spectrum scan, starting a data packet transfer, entering a discontinuous reception (DRX) wake up mode, starting a phone call, and starting an emergency phone call; and
causing the antenna to be extended.

2. The method of claim 1 wherein causing the antenna to be extended comprises displaying a message on a display screen of the communications device for alerting a user of the communications device to extend the antenna.

3. The method of claim 1 wherein causing the antenna to be extended comprises producing an audible tone for alerting a user of the communications device to extend the antenna.

4. The method of claim 1 wherein causing the antenna to be extended comprises utilizing a motor of the communications device to extend the antenna.

5. The method of claim 4 wherein the motor is capable of being disabled by a user of the communications device.

6. The method of claim 1 further comprising:
detecting occurrence of an event selected from a group consisting of: ending an RF spectrum scan, ending a data packet transfer, entering a DRX sleep mode, ending a phone call, and an emergency phone call having been completed for a first predetermined period of time; and
causing the antenna to be retracted.

7. The method of claim 6 wherein causing the antenna to be retracted comprises displaying a message on a display screen of the communications device for alerting a user of the communications device to retract the antenna.

8. The method of claim 6 wherein causing the antenna to be retracted comprises producing an audible tone for alerting a user of the communications device to retract the antenna.

9. The method of claim 6 wherein causing the antenna to be retracted comprises utilizing a motor of the communications device to retract the antenna.

10. The method of claim 1 wherein the communications device is a mobile station.

11. A method for controlling retraction of an antenna in a communications device, the communications device comprising an antenna capable of being retracted, the method comprising:
detecting occurrence of an event selected from a group consisting of: ending a radio frequency (RF) spectrum scan, ending a data packet transfer, entering a discontinuous reception (DRX) sleep mode, ending a phone call, and an emergency phone call having been completed for a first predetermined period of time; and
causing the antenna to be retracted.

12. The method of claim 11 wherein causing the antenna to be retracted comprises displaying a message on a display screen of the communications device for alerting a user of the communications device to retract the antenna.

13. The method of claim 11 wherein causing the antenna to be retracted comprises producing an audible tone for alerting a user of the communications device to retract the antenna.

14. The method of claim 11 wherein causing the antenna to be retracted comprises utilizing a motor of the communications device to retract the antenna.

15. The method of claim 11 further comprising:
detecting occurrence of an event selected from a group consisting of: starting an RF spectrum scan, starting a data packet transfer, entering a DRX wake up mode, starting a phone call, and starting an emergency phone call; and
causing the antenna to be extended.

16. The method of claim 15 wherein causing the antenna to be extended comprises displaying a message on a display screen of the communications device for alerting a user of the communications device to extend the antenna.

17. The method of claim 15 wherein causing the antenna to be extended comprises producing an audible tone for alerting a user of the communications device to extend the antenna.

18. The method of claim 15 wherein causing the antenna to be extended comprises utilizing a motor of the communications device to extend the antenna.

19. The method of claim 18 wherein the motor is capable of being disabled by a user of the communications device.

20. The method of claim 11 wherein the communications device is a mobile station.
